(19) United States
(12) Patent Application Publication
(10) Pub. No.: US 2006/0244723 A1
(43) Pub. Date: Nov. 2, 2006

(54) Method of using a mouse to carry out multimedia adjustments

(76) Inventors: Ching-Tzu Chen, Banqiao City (TW); Chien-Pei Lee, Banqiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/116,240

(22) Filed: Apr. 28, 2005

(51) Int. Cl. G09G 5/08

(52) U.S. Cl. 345/163

(57) ABSTRACT

A method of using a mouse to carry out multimedia adjustments is disclosed. A conversion program is used to define and switch between at least two key function sets so as to allow a user to use the mouse to carry out adjustments on the selected multimedia files without moving the cursor.

### BACKGROUND OF THE INVENTION

1. Field of the Invention

The invention generally relates to a method of using a mouse to carry out multimedia adjustments. More particularly, the invention relates to a method, wherein such method includes a conversion program so that the mouse may have two key function sets so as to allow a user to use the mouse to carry out adjustments on the selected multimedia files without moving the cursor.

2. Description of the Prior Art

As of now, computers have been widely used and have linked more closely to our life. New-generation home computers may be used to play the video and audio files in the forms of VCD, DVD and MP3 in addition to document processing.

In the prior art, a user has to move the mouse to aim the cursor at one of the control keys shown on the screen to carry out multimedia adjustments, such as the activation of the multimedia program/play/pause, stop, volume adjustment, mute, last song, next song, full screen/not full screen and ejection. Hence, a user can not carry out such adjustments in an easy manner.

Especially, when people view a movie, the optimal viewing distance is usually more than one meter from the monitor; if people need to do adjustments (such as volume adjustment and screen size adjustment), they have to move closer to the monitor in order to carry out the adjustments (even with a wireless mouse, people still have to move closer to the monitor).

To eliminate the disadvantages of the prior art, the inventor has put in a lot of effort in the subject and has come up with the method of the present invention.

### SUMMARY OF THE INVENTION

The object of the present invention is to provide a method of using a mouse to carry out multimedia adjustments. A user may use a key to switch to the multimedia mode so as to carry out multimedia adjustments. Hence, adjustments may be carried out in an easier and more convenient manner.

To reach the goal, a method of using a mouse to carry out multimedia adjustments is disclosed. The method comprises a mouse connected with a computer, wherein a multimedia program and a conversion program are installed in the computer, and wherein the mouse have a plurality of function keys and one or more switching keys, which may be used to activate the conversion program, the conversion program defines at least two key functions sets so that the function keys may correspond to the adjustment functions of the multimedia program, and wherein after we turn on a computer, we may use the mouse to activate the multimedia program to carry out adjustments according to the following procedure:
(a) First, after the computer is turned on, the function keys of the mouse correspond to the adjustment functions of the regular window operating system;
(b) Press the switching key to activate the conversion program so as to switch to the second key function set;
(c) Check whether the multimedia program is activated; if the multimedia program is activated, we may press a function key of the mouse to select a multimedia file; if the multimedia program is not activated, we may press the left key to activate the multimedia program;
(d) Click on a key of the mouse to play the selected files; we may use the keys of the mouse to carry out adjustments/controls;
(e) After the files are played, we may select other files; if we do not want to play more multimedia file, we may press the switching key to close the conversion program and switch back to the regular mode, which corresponds to the regular functions of the window operating system; now, the playing ends.

### BRIEF DESCRIPTION OF THE DRAWINGS

FIG. 1 is a block diagram schematically illustrating the flow of an embodiment of the present invention.

FIG. 2 is a diagram schematically illustrating the two key function sets of a mouse of the present invention.

### LIST OF REFERENCE NUMERALS

1—The mouse is under the regular mode

2—Click on the multimedia program to activate it

3—Press the conversion key to activate the conversion program

4—To switch to the second key function set

5—Check whether the multimedia program is activated

6—Press the left key a to activate the multimedia program

7—Press a function key of the mouse to select a multimedia file

8—Press the eighth key i so that the holder of CD drive may slide out and we may place a CD/VCD on the holder.

9—Press the eight key i again so that the holder may slide in and the CD/VCD may be played

10—Press the switching key to switch to the regular mode

11—Select one or more files from the hard disk or memory

12—Press the switching key to switch back to the multimedia mode

13—Press the left key a to play the selected files

14—After the files are played

15—We may select other files

16—Close the conversion program

17—Switch back to the regular mode

18—The playing ends

a—Left key

b—Right key

c—Ball type key

d—Middle key

e—Fourth key

f—Fifth key

g—Sixth key

h—Seventh key

i—Eighth key

### DETAILED DESCRIPTION OF THE PREFERRED EMBODIMENT

The embodiments of the present invention will be elaborated in the following with reference to the drawings so that the patent review members may easily understand the structure, use and characteristics of the present invention.

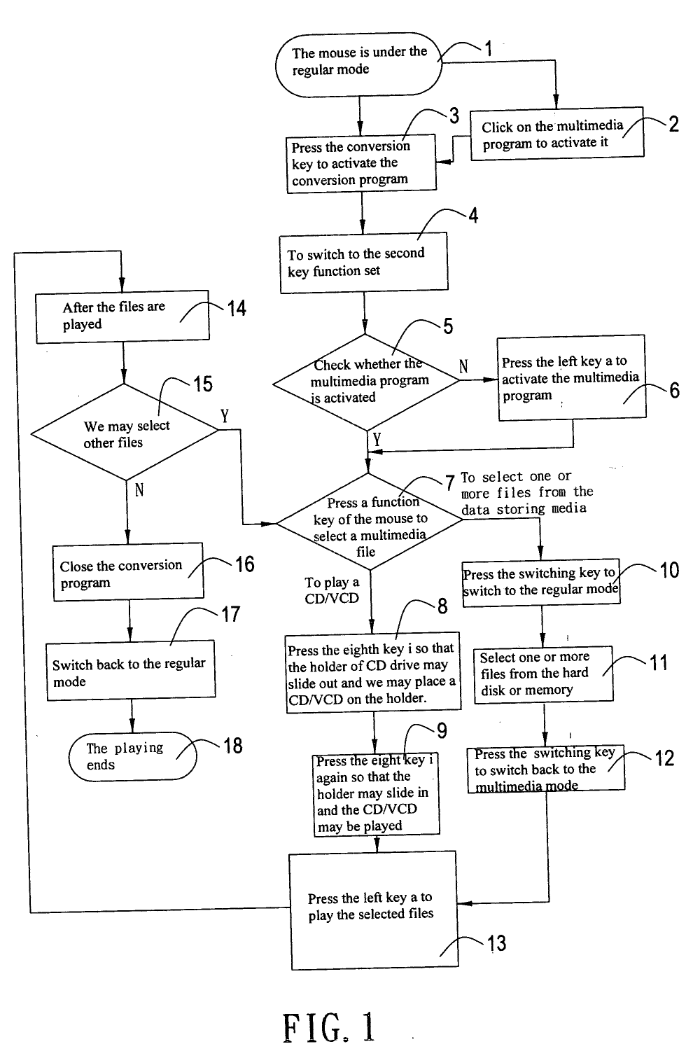

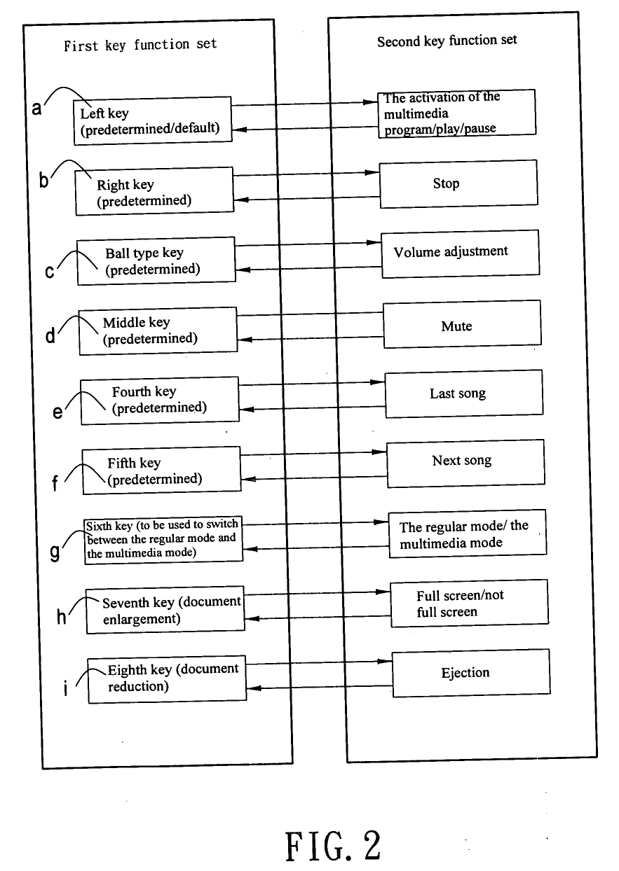

As illustrated in FIG. 1 and FIG. 2, the method of the present invention comprises a mouse connected with a computer, and a multimedia program and a conversion program are installed in the computer. The multimedia program may be Media Player. The conversion program defines two key function sets of the mouse; the first key function set corresponds to the adjustment functions/keys of the regular window operating system, and the second key function set corresponds to the adjustment functions/keys of the multimedia program. The mouse has eight function keys, and these eight function keys may be ordinary key, ball type key or stick type key. In this embodiment, the eight functional keys are a left key a, a right key b, a ball type key c, a middle key d, a fourth key e, a fifth key f, a seventh key h and an eighth key i. When a user switches to the first key function set, these eight keys are linked to the adjustment keys of the regular window operating system; when a user switches to the second key function set, these eight keys are linked to the adjustment functions/keys of the multimedia program. The mouse also has a sixth key g, which is used as the switching key to switch between the regular mode (corresponding to the first key function set) and the multimedia mode (corresponding to the second key function set). The eight function keys of the mouse, under the regular mode, have the predetermined/default left key function, predetermined right key function, predetermined ball type key function, predetermined middle key function, predetermined fourth key function, predetermined fifth key function, document enlargement function and document reduction function, respectively. Also, the eight function keys of the mouse, under the multimedia mode, have the functions of the activation of the multimedia program/play/pause, stop, volume adjustment, mute, last song, next song, full screen/not full screen and ejection, respectively.

After we turn on a computer, we may use the mouse to activate the multimedia program to carry out adjustments according to the following procedure:

After we turn on a computer, the mouse is under the regular mode 1 and the keys of the mouse correspond to the adjustment keys of the regular window operating system. Now, we can click on the multimedia program 2 to activate it.

Press the switching key to activate the conversion program 3 so as to switch to the second key function set 4.

Check whether the multimedia program is activated 5. If the multimedia program is activated, we may press a function key of the mouse to select a multimedia file 7, which may be a video file or an audio file. If the multimedia program is not activated, we may press the left key a to activate the multimedia program 6.

Such a file may be from a CD/VCD or from a hard disk or a memory installed in the computer. If such file is from a CD/VCD, we can press the eighth key i (under the multimedia mode) of the mouse; now the holder of the CD drive may slide out and we may place a CD/VCD on the holder 8. We may then press the eighth key i again so that the holder may slide in and the CD/VCD may be played 9. If such file is from a hard disk or a memory installed in the computer, first, we press the switching key to switch to the regular mode 10 and then select one or more files from the hard disk or memory 11. Now, we may press the switching key to switch back to the multimedia mode 12.

Now, we may press the left key a to play the selected files 7. When a file is being played, we may use the 8 keys (the left key a, right key b, ball key c, middle key d, fourth key e, fifth key f, seventh key h and eighth key i) of the mouse to carry out adjustments/controls, such as play/pause, stop, volume adjustment, mute, last song, next song, full screen/not full screen and ejection.

After the files are played 14, we may select other files 15. If we decide to select other files, we will go to the step 7. If not, we may press the switching key to close the conversion program 16 and switch back to the regular mode 17, which corresponds to the adjustment keys of the regular window operating system. Now, the playing ends 18.

From the above, we can see that the conversion program allows us to switch between the regular (window operating system) mode (corresponding to the first key function set) and the multimedia mode (corresponding to the second key function set); we may switch to the latter to carry out adjustments/controls (such as play/pause, stop, volume adjustment, mute, last song, next song, full screen/not full screen and ejection) in a more convenient manner.

In another embodiment, two of the function keys of the mouse may be used together to send out a single command under the regular mode or the multimedia mode.

The present invention may be used for a mouse with two function keys—a right key a and a left key b. Under the regular mode, these two keys have the predetermined/default right and left key functions. Under the multimedia mode, the right and left keys have the activation of the multimedia program/play/pause functions and stop function, respectively. When a multimedia file is played, a user may switch to the multimedia mode and use the adjustment keys to carry out the activation of the multimedia program/play/pause and stop.

From the above, we can see that the present invention has the following two advantages:
1. When a song or a movie is played, we do not need to click on the adjustment keys shown on the monitor in order to carry out adjustments; we may use the function keys of the mouse to carry out adjustments.
2. Hence, the present invention allows us to stay at an optimal viewing/listening location while we carry out such adjustments.

What hereinbefore described are only the embodiments of the present invention, and these embodiments should not limit the scope of the present invention. Many changes and modifications in the above described embodiments of the invention can, of course, be carried out without departing from the scope thereof.

From the above, we can see that the present invention may allow users to carry out multimedia adjustments in an easier and more convenient manner. It is hoped that the patent review members may approve this patent application.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method of using a mouse to carry out multimedia adjustments, wherein the method comprises a mouse connected with a computer, and a multimedia program and a conversion program are installed in the computer, and wherein the mouse have a plurality of function keys and one or more switching keys, which may be used to activate the conversion program, the conversion program defines at least two key function sets so that the function keys of the mouse may correspond to the adjustment functions of the multimedia program, and wherein after we turn on a computer, we may use the mouse to activate the multimedia program to carry out adjustments according to the following procedure:
(a) First, after the computer is turned on, the function keys of the mouse correspond to the adjustment functions of the regular window operating system;
(b) Press the switching key to activate the conversion program so as to switch to the second key function set;
(c) Check whether the multimedia program is activated; if the multimedia program is activated, we may press a function key of the mouse to select a multimedia file; if the multimedia program is not activated, we may press the left key to activate the multimedia program;
(d) Click on a key of the mouse to play the selected files; we may use the keys of the mouse to carry out adjustments/controls;
(e) After the files are played, we may select other files; if we do not want to play more multimedia file, we may press the switching key to close the conversion program and switch back to the regular mode, which corresponds to the regular functions of the window operating system; now, the playing ends.

2. A method as in claim 1, wherein, if a file to be selected is from a CD/VCD, while under the multimedia mode, we may press one key of the mouse so that the disc holder may slide out, we may then place a CD/VCD on the holder and press another key of the mouse to play the file.

3. A method as in claim 1, wherein, if a file to be selected is from a data storing medium, we may press the switching key to switch to the regular mode and then select one or more multimedia files from the hard disk or memory.

4. A method as in claim 1, wherein the data storing medium is a hard disk installed in the computer.

5. A method as in claim 1, wherein the data storing medium is a memory installed in the computer.

6. A method as in claim 1, wherein the function keys of the mouse are ordinary keys.

7. A method as in claim 1, wherein the function keys of the mouse are ball type keys.

8. A method as in claim 1, wherein the function keys of the mouse are stick type keys.

9. A method as in claim 1, wherein the conversion program may be used to switch between the first key function set and the second key function set, and a user may use a switching key of the mouse to carry out such switch.

10. A method as in claim 9, wherein the keys of the mouse correspond to the adjustment functions of the regular window operating system under the regular mode and correspond to the adjustment functions of the multimedia program under the multimedia mode.

11. A method as in claim 10, wherein the number of the keys of the mouse may be increased or decreased.

12. A method as in claim 10, wherein a key of the mouse may correspond to several adjustment functions of the window operating system under the regular mode and may correspond to several adjustment functions of the multimedia program under the multimedia mode.

13. A method as in claim 10, wherein two of the function keys of the mouse may be used together to send out a single command under the regular mode or the multimedia mode.

14. A method as in claim 10, wherein the mouse has at least two function keys, and the two keys have the predetermined/default left key and right key functions under the regular mode and have the functions of the activation of the multimedia program/play/pause and stop, respectively.

15. A method as in claim 10, wherein the mouse has eight function keys: a left key, a right key, a ball type key, a middle key, a fourth key, a fifth key, a seventh key and an eighth key, the mouse also has a sixth key, which may be used to activate the conversion program and switch between the regular mode and the multimedia mode.

16. A method as in claim 15, wherein the eight function keys, under the regular mode, have the predetermined/default left key function, predetermined/default right key function, predetermined/default ball type key function, predetermined/default middle key function, predetermined/default fourth key function, predetermined/default fifth key function, document enlargement function and document reduction function, respectively, and wherein the eight function keys, under the multimedia mode, have the functions of the activation of the multimedia program/play/pause, stop, volume adjustment, mute, last song, next song, full screen/not full screen and ejection, respectively.

17. A method as in claim 1, wherein the multimedia program is Media Player.

18. A method as in claim 1, wherein the multimedia file is a video file.

19. A method as in claim 1, wherein the multimedia file is an audio file.
